(19) United States
(12) Patent Application Publication
(10) Pub. No.: US 2001/0024698 A1
(43) Pub. Date: Sep. 27, 2001

(54) Methods for the selective incorporation of colorants and incompatible components into optical fiber coating composition

(76) Inventors: Jibing Lin, St. Charles, IL (US); Lindsay S. Coons, St. Charles, IL (US); Timothy L. Toennis, Aurora, IL (US); Timothy E. Bishop, Algonquin, IL (US); James Turner, Frankfort, IL (US); Paul E. Snowwhite JR., Muskego, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/861,912

(22) Filed: May 21, 2001

Related U.S. Application Data
(62) Division of application No. 09/506,131, filed on Feb. 17, 2000.

(51) Int. Cl. B05C 11/00

(52) U.S. Cl. 427/501; 118/75

(57) ABSTRACT

Method and related system for continuous and selective addition of a colorant and/or incompatible component into a radiation-curable coating composition comprising introducing a stock coating composition (primary coating, secondary coating, ink or matrix material) comprising a radiation-curable components (e.g., reactive acrylates) into a mixing zone having a primary inlet and an outlet; selectively adding at least one colorant (dye, pigment) and/or incompatible component (crystal-forming, hydrolyzate-forming, haze-forming) to the stock coating composition upstream of the mixing zone outlet; mixing the at least one colorant and/or incompatible component and stock coating composition in the mixing zone to provide a radiation-curable finished coating composition; continuously applying the finished coating composition onto an optical fiber; and curing the finished coating composition.

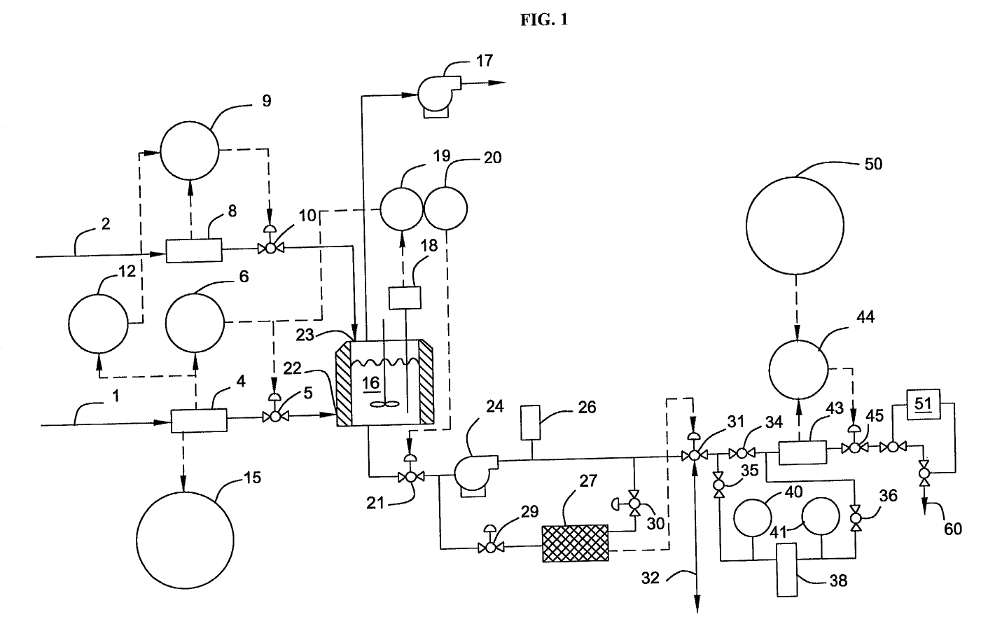

### TECHNICAL FIELD OF THE INVENTION

The present invention generally pertains to the field of optical fibers and, more specifically, to coating compositions for optical fibers.

### BACKGROUND OF THE INVENTION

Optical fibers, bundled together to provide fiber optic ribbons and cables, are used extensively in the telecommunications industry to transport large volumes of analog and digital data over long distances. The ability of the fibers to be properly installed, and to then successfully transport data, depends in part on the performance of the coatings applied to the exterior of each fiber strand.

In producing optical fiber products, up to four, and possibly more, coating compositions may be applied onto each fiber strand. The first coating, commonly referred to as an inner primary coating (also referred to as, simply, a primary coating), is applied directly onto the optical fiber. This coating is usually a soft coating having a low glass transition temperature, and provides resistance to microbending. Microbending is undesirable, as it can lead to attenuation of the signal transmission capability of the optical fiber. Thereafter, and optionally, an outer primary coating (also referred to as a secondary coating) may be applied. This coating is typically harder than the primary coating, and provides resistance to handling. A color is often incorporated into the outer primary coating to assist in identification. A third coating, usually referred to as an ink, is optionally applied onto the outer primary coating, but may be applied onto the inner primary coating in the absence of an outer primary coating. The ink provides an ancillary means of identifying the fiber. Finally, a plurality of the foregoing fibers is arranged, usually in parallel. A fourth type of coating composition, commonly referred to as matrix material, is applied to the arranged fibers. The matrix material maintains the fibers in a spaced configuration, commonly referred to as a ribbon. If desired, one or more ribbons may be arranged in parallel and joined by either edge coating or by encapsulation using the same or different matrix material. In the latter case, the matrix materials may be referred to as inner and outer matrix materials. These ribbons, which may be bundled to form cables, facilitate the handling and installation of optical fibers.

The economics of the optical fiber industry demand that each of the foregoing coatings, which are applied as a liquid, be applied and solidified as quickly as possible. To achieve this objective, the industry has turned to radiation-curable compositions. These compositions are favored because they can be applied in the form of a liquid, and cured to provide a solid upon exposure to radiation, within a few seconds. This quick-curing property permits inner and outer primary coatings to be applied and cured in succession on a single optical fiber, even when the fiber is moving at speeds in excess of 15 m/s.

Formulating the foregoing coating compositions to provide the desired performance characteristics is challenging. In one respect, each type of coating must be viewed independently; each coating must have certain individual properties because each must perform different functions. However, because the coatings are applied onto a single fiber, there exists a critical interrelationship between the coatings. Accordingly, and significantly, inner and outer primary coatings, inks and matrix materials are typically engineered to work in concert with one another, and are purchased by coated fiber producers in significant part on the basis of their performance when used together, e.g., whether the finished fiber optic product achieves the desired performance levels.

To meet varying customer requirements without sacrificing coating compatibility, an optical fiber producer will typically inventory a wide variety of coatings, in a variety of colors. For example, a producer may desire to provide a fiber ribbon consisting of green, blue, yellow and orange fibers, with no ink printing, assembled using a transparent inner matrix material, while also producing a second fiber ribbon consisting of red, purple, white and pink fibers, with ink printing, and a colored inner matrix material. This example alone requires an inventory of one inner and either outer primary coatings, up to eight ink coatings, and two inner matrix materials.

The necessity of maintaining a large inventory of many coating compositions, in varying colors, to satisfy varying customer demands, is unnecessarily confusing, expensive, and can result in one or more of those compositions lying unused for long periods. These compositions deteriorate over time, with some eventually becoming unusable, resulting in a loss. Merely lowering inventories, however, does not provide a complete solution. Maintaining maximum flexibility in today's just-in-time business environment requires an optical fiber producer to maintain a broad inventory to ensure that adequate supplies of the various types of coatings are available to react to order changes and rush orders. The ability of an optical fiber producer to adjust its production to quickly meet changes in customer requirements can mean the difference between retaining and losing a customer.

In addition to the foregoing inventory related issues, coating producers are continually seeking new compositions that provide enhanced performance, or performance levels comparable to that of existing coatings, but at lower cost. However, to date, the inclusion of certain potentially performance-enhancing components has not been possible because of their inherent incompatibilities with coating compositions. For example, over time, and under typical storage and shipping conditions, certain potentially beneficial components are known to degrade, forming crystals. The presence of crystals in a coating composition adversely impacts fiber performance, e.g., in an inner primary coating, crystals can cause an undesirable increase in signal attenuation. For this reason, many beneficial crystal-forming components are not presently included in optical fiber coatings. Other components, such as adhesion promoters that can become unstable and form hydrolyzates in the presence of moisture, and silicones which can introduce haze into uncured coatings, can also be termed incompatible because of the difficulties encountered when incorporating them into coatings.

The foregoing demonstrates a need for a method of providing colored optical fiber products that does not require an excessive inventory, and which permits maximum manufacturing flexibility without an undue sacrifice in product performance. A further need exists for a method of providing coating compositions that include beneficial, yet partially or wholly incompatible, components into such compositions, such as crystal-, hydrolyzate- and haze-forming components.

### BRIEF SUMMARY OF THE INVENTION

The present invention meets the foregoing and other needs by providing unique and novel methods that provide a producer of optical fibers tremendous flexibility in quickly and easily adapting a stock (or standard) radiation-curable coating composition to the producer's specifications at the producer's facility.

The present invention comprises, but is not limited to, the steps of continuously introducing a radiation-curable stock coating composition comprising at least one radiation-curable component into a mixing zone having a primary inlet and an outlet; selectively adding at least one additive selected from the group consisting of a colorant and an incompatible component to the stock coating composition upstream of the mixing zone outlet; mixing the at least additive and stock coating composition in the mixing zone to provide a radiation-curable finished coating composition; and continuously applying the finished coating composition onto an optical fiber. The finished coating composition may then be cured by exposure to appropriate radiation.

By way of example only, and without limiting the scope of the inventive method, the foregoing method permits an optical fiber producer to, on demand and at the producer's facility, add one, two or more colors to a stock coating composition, thereby quickly providing a composition with a desired tint. Present, and less desirable, alternatives include ordering the tinted composition from a supplier and waiting for delivery, or pulling the tinted composition from an existing, potentially stale (and thus unusable) inventory. The inventive method also allows a producer to quickly adapt its manufacturing to meet unexpected customer demand. Further benefits are provided in the form of decreased waste, and a lowering of inventory required to produce fibers of a variety of colors. More specifically, inventory is simplified because only one stock composition and several colorants need be inventoried to provide a coating composition in a variety of colors. The foregoing benefits are achieved without any adverse impact on the performance of the individual coatings, or on the compatibility and resulting combined performance of the coatings when applied onto a single optical fiber.

In another aspect, the present invention provides a means by which certain additives, heretofore excluded from coating compositions due to their initial or subsequent incompatibility therewith, e.g., crystal-, hydrolyzate- and haze-forming components, can be successfully incorporated into such compositions. By incorporating one or more incompatible components in accordance with the inventive method, a coating can be produced, applied onto an optical fiber and cured before an incompatible component is able to cause performance problems in the coating.

Of course, the inventive method contemplates the selective incorporation of one or more additives, in a variety of combinations. For example, a colorant and an incompatible component may be incorporated into a stock composition simultaneously with, independently of, or to the exclusion of, one another.

In addition to the foregoing method, a system of providing a finished radiation-curable fiber optic coating composition continuously prepared by the selective introduction of a colorant or other additive, as described herein, to a stock coating composition is provided.

The invention may best be understood with reference to the accompanying FIGURE and in the following detailed description of the preferred embodiments.

### BRIEF DESCRIPTION OF THE DRAWING

The FIGURE is a schematic diagram of a preferred apparatus capable of continuously providing a radiation-curable coating composition that includes at least one additive selected from colorants and/or incompatible components to a fiber optic coating device, such as a draw tower, in accordance with the methods of the present invention.

The inventive methods are described in the following paragraphs with an emphasis on preferred embodiments. However, it will be obvious to those of ordinary skill in the art that variations of the preferred embodiments may be successfully used, and that it is intended that the invention may be practiced otherwise than as specifically described herein. The inventive methods should therefore not be construed as being limited to the preferred embodiments described herein.

### DESCRIPTION OF THE PREFERRED EMBODIMENTS

The present invention provides for the incorporation of certain additives, colorants, incompatible components, and mixtures thereof, into coating compositions. For purposes of simplicity, the description of the present invention will be provided in connection with only one embodiment thereof-the incorporation of one or more colorants, e.g., dyes, pigments, into one or more of the optical fiber coating compositions described previously. However, those skilled in the art will appreciate that the description is applicable to the incorporation of one or more additives into such compositions. Accordingly, references herein to the methodology for incorporating one or more colorants into a coating composition (or references to apparatus associated therewith) should be understood as relating to incompatible components (and mixtures of colorants and incompatible components) as well. By way of specific example, a reference to a colorant flow controller would be understood as referring to a flow controller for an incompatible component.

The term “incompatible” as used herein in connection with describing additives that can now successfully be incorporated into coating compositions by resort to the inventive method should be understood as including crystal-forming components, haze-forming components, as well as components that are unstable in coating compositions, e.g., components that can degrade under typical warehouse storage conditions. Examples of unstable components include those that form hydrolyzates in the presence of moisture, such as adhesion promoters. Those skilled in the art, upon reference to the description provided herein, should be capable of identifying incompatible components that are suitable for introduction into coating compositions using the method of the present invention.

Turning now to the preferred embodiment, the inventive method may be used to selectively add one or more colorants and/or one or more incompatible components to virtually any radiation-curable coating composition useful for coating optical fibers, e.g., inner and outer primary coating compositions, ink compositions and inner and outer matrix material compositions. Accordingly, as used herein, references to applying a coating onto an optical fiber includes applying a coating onto an uncoated optical fiber (e.g. applying an inner primary coating composition) as well as onto a previously coated optical fiber (e.g., applying an outer primary, secondary, ink and/or inner or outer matrix material coating compositions). As the various components of these curable compositions are well-known to those skilled in the art, and the precise composition of these curable compositions are not critical to the successful use of the present invention, they will not be discussed in detail herein. Illustrative of suitable coatings are those set forth in U.S. Pat. No. 4,624,994, 4,682,851, 4,782,129, 4,794,133, 4,806,574, 4,849,462, 5,219,896 and 5,336,563.

Generally, and for purposes of the present invention, the coating composition need only comprise a single radiation-curable component. However, more than one such component is commonly included in radiation-curable coating compositions to provide the desired properties in the cured coating.

The radiation-curable functionality present in such components is typically ethylenic unsaturation, which can be polymerized through radical polymerization or cationic polymerization. Specific examples of suitable functionalities that include ethylenic unsaturation are acrylates, methacrylates, styrenes, vinylethers, vinyl esters, N-substituted acrylamides, N-vinyl amides, maleate esters, and fumarate esters. Preferably, the radiation-curable component contains an acrylate, methacrylate, N-vinyl, or styrene functionality.

Other functional groups that can be present in radiation-curable components are epoxy groups, or thiol-ene or amine-ene systems. Epoxy groups can be polymerized through cationic polymerization, whereas the thiol-ene and amine-ene systems are usually polymerized through radical polymerization The type and amount of radiation-curable components included in the stock coating composition can vary widely, and are not critical to the successful incorporation of colorant and/or incompatible component into the composition. However, the amount of such components should advantageously range between about 15 wt. % and 99 wt. % of the finished composition, and preferably range between about 30 wt. % and 95 wt. %.

In practicing the inventive method, one should consider the well-known effect of certain radiation-curable components, e.g., reactive acrylates, on the viscosity of the composition. For example, some acrylates may increase the viscosity of the composition to a level that frustrates the mixing and coating contemplated by the present invention. The selection and inclusion of radiation-curable components should thus be undertaken with this in mind to ensure enjoyment of the benefits provided by the present invention.

As mentioned previously, the inventive method finds particular utility in introducing one or more colorants into any of the foregoing coatings. Colorants suitable for inclusion in the coating compositions can vary widely, e.g., dyes, both reactive and unreactive dyes, dye precursors, pigments, and the like. Dyes are preferred due to their relatively good solubility in most coating compositions.

Illustrative of dyes suitable for inclusion in the coating compositions include polymethine dyes, di and triarylmethine dyes, aza analogues of diarylmethine dyes, aza (18) annulenes (or natural dyes), nitro and nitroso dyes, azo dyes, anthraquinone dyes and sulfur dyes. These dyes are well known in the art, and will therefore not be described in detail herein.

Dyes or dye precursors useful in the radiation-curable coatings of the present invention can be reactive compounds. Preferably, the reactive dye or dye precursor is itself radiation-curable, and becomes chemically bonded in the cured polymeric coating. Reactive dyes or dye precursors may advantageously be used to impart color to the coating composition in place of pigments to avoid concerns associated with pigment particle size, pigment dispersion and the like. Reactive dyes or dye precursors also provide coatings in which dye migration is reduced, thereby minimizing dye agglomeration in the cured, finished coating. Reactive dyes or dye precursors further reduce dye breakout or extractability in the cured, finished coating.

The reactive dyes and dye precursors can be made by reacting a linking compound, which includes a radiation-curable functionality, with a dye or dye precursor. Dyes or dye precursors that have a reactive functionality that is not a part of the chromophore, or which can be chemically modified to include a reactive functionality without adversely affecting the chromophore can be used to form the reactive dyes and dye precursors. Similar considerations apply to colorless dyes that will change to a color upon exposure to ultraviolet radiation during cure.

The reactive functionality in the dye or dye precursor can be any group that is capable of reacting with a linking group that is used to make the reactive dyes or dye precursors. Illustrative of reactive functionalities that are found in, or can be added to, dyes or dye precursors include, but are not limited to, hydroxyl, amino, including secondary amino, thiol, carboxyl, mercapto, vinyl, acryl, epoxy, carbamate, or the like. Any of the dyes or dye precursors described herein can be used as the chromophore.

The linking compound desirably comprises a radiation-curable functionality and a second functionality capable of reacting with the reactive functionality of the dye or dye precursor. Preferably, the radiation-curable functionality of the linking group is ethylenic unsaturation, which can be polymerized through radical polymerization or cationic polymerization. For example, suitable compounds that contain ethylenic unsaturation are acrylates, methacrylates, styrene, vinyl ether, vinylester, N-substituted acrylamide, N-vinyl amide, maleate esters, fumarate esters and the like. Other types of compounds that can be used to form the reactive dyes or dye precursors are compounds which include at least one of an epoxy group, a thiol-ene or an amine-ene, as described in more detail herein.

One color-forming system suitable for use in the present invention comprises a substantially colorless dye precursor and a cationic photoinitiator. The dye precursor can be any colorless dye which is capable of forming a chromophore in the presence of at least one monomer or oligomer having a radiation-curable functional group which can form free radicals in the presence of actinic radiation and a photoinitiator for the monomer or oligomer and in the presence of a cation. It will be appreciated by those skilled in the art that the selection of the dye precursor will be dependent on the desired color for the cured coating. For example, if the cured coating is to be green, then the dye precursor is selected so that the chromophore formed during cure is green. Similarly, more than one dye precursor may be included in the coating composition. Use of a mixture allows for a broad spectrum of colors to be achieved in the cured coating.

Dye precursors that have been found useful in the practice of the present invention include dye precursors that have the fluorane structure. Copikem dyes commercially available from B.F. Goodrich Specialty Chemicals are useful dye precursors. Leuco dyes are also suitable dye precursors, e.g., isobenzofuranones. Among the isobenzofuranones that are useful in the present invention are 2′phenylamino-3′-methyl-6′(dibutylamino) spiro-[isobenzofuran-1(3H),9′-(9H)xanthen]-3-one; 2′-di(phenylmethyl)amino-6′-(diethylamino)spiro (isobenzofuran1(3H),9′-(9H)xanthen)-3-one; 6′-(diethylamino)-3′-methyl-2′-(phenylamino)spiro) isobenzofuran-1(3H), 9′-(9H)xanthen)-3-one; 6-(dimethylamino)-3,3-bis(4dimethylamino)phenyl-1(3H)-isobensofiranone; and 3,3-bis(1-butyl-2-methyl-1H-indol-3-yl)-1-(3H)-isobenzofuranone.

Suitable dye precursors also include phthalide-type color formers. Phthalide-type color formers include, for example, diarylmethane phthalides, monoarylmethane phthalides, alkenyl substituted phthalides, including, by way of illustration, 3-ethylenyl phthalides, 3,3-bisethylenyl phthalides and 3-butadienyl phthalides. Bridged phthalides, including spirofluorene phthalides, spirobenzanthracene phthalides can also be used. Bisphthalides may also be used.

The amount of colorant that may be added using the inventive method can vary widely, and depends upon the particular colorant selected and the desired fiber coloration. Advantageously, however, the colorant should comprise up to 10 wt. % of the final uncured colored composition, and preferably comprises from about 0.1 wt. % to about 5 wt. % of that composition.

As mentioned previously, a wide range of incompatible, yet beneficial, components are candidates for incorporation into coating compositions in accordance with the inventive method. Examples of such incompatible components include silicones that induce haze into the uncured composition, crystal-forming components, and adhesion promoters that, while initially compatible with the coating, are unstable, forming hydrolyzates in the presence of moisture.

A variety of silicone-containing components, when introduced into clear coating compositions, induce a visible haze in the composition. Illustrative of such components are 3501 Silicone and 7601 Coat-O-Sil. This haze is believed to be induced by the poor solubility of these components in the coating compositions, and not due to the formation of crystals.

The use of adhesion promoters in primary coating compositions to enhance the adhesion of the composition onto the glass surface of the optical fiber is desirable, and well known. However, these components are incompatible in the sense that they are unstable, e.g., they hydrolyze gradually in the presence of moisture. Accordingly, inner primary coatings that include these promoters must be stored under moisture-free conditions prior to use. The present invention, which incorporates the promoters just prior to use, precludes the need for such special handling.

Examples of adhesion promoters, which are typically incorporated into primary coatings at levels of from about 0.1 wt. % to about 30 wt. %, are provided in U.S. Pat. No. 5,977,202. These adhesion promoters include trialkoxysilanes, such as γ-methacryloxypropyltrimethoxysilane, γ-acryloxypropyltrimethyoxysilane, γ-mercaptopropyltrimethoxysilane and γ-aminopropyltriethoxysilane, γ-aminopropyltrimethoxysilane, N-β-(aminoethyl)-γ-aminopropyltriethoxysilane, bis-(γ-trimethoxysilylpropyl)amine, N-phenyl-γ-aminopropyltrimethoxysilane and N-methyl-γ-aminopropyltrimethoxysilane.

Crystal-forming components that can be incorporated into coatings in accordance with the present invention include those that are in a crystalline state prior to introduction into the coating composition, as well as those that are initially provided in solution, but which crystallize after introduction into the coating composition. It is believed that the subsequent crystallization of these components is a result of the relatively poor solubility of the crystal-forming compound in the coating composition.

A significant number of known crystal-forming components fall within three general categories: (a) antioxidants/stabilizers, (b) photoinitiators and (c) low molecular weight ethylenically unsaturated components, sometimes referred to in the art as reactive diluents. By way of illustration only, and without intending to limit the identity of crystal-forming components that may be added in accordance with the inventive method, the following examples of crystal-forming components are provided: (a) stabilizers and/or antioxidants, including, but not limited to, phenolic antioxidants, aromatic amines, sulphides, phosphites, metal-containing stabilizers, bifunctional stabilizers, polyfunctional stabilizers, UV stabilizers such as hydroxybenzotriazoles, anilides and benzoates, light stabilizers such as hindered amine stabilizers; (b) photoinitiators, including, but not limited to, 2,4,6-trimethylbenzoyldiphenyl phosphine oxide, bis(2,6-dimethoxybenzoyl)-2,4,4-trimethylphenyl phosphine oxide and 2-benzyl-2-N,N-dimethylamino-1-(4-morpholinophenyl)-1-butanone; and (c) low molecular weight, radiation-curable, ethylenically-unsaturated compounds, including, but not limited to, N-vinyl caprolactam, N-vinyl formamide, acrylamide and methylene bisacrylamide. Of course, one or more of any incompatible component may advantageously be added to a particular coating composition, in accordance with the present invention.

The identification of beneficial incompatible components that may nevertheless be incorporated into a usable finished coating composition may be further identified by an examination of the effect of such components on a normally transparent coating composition. In particular, one or more of the following procedures may be used to identify incompatible components that can be incorporated into a coating composition in accordance with the inventive method.

One or more of the following methods may be used to identify a crystal-forming component. In one method, a final coating composition (with the suspected incompatible component mixed therein) and a control composition (without the suspected component) are stored at −20° C. for at least one week. If a visible haze or cloudiness develops in the former, but not in the latter, the suspected component is a candidate for introduction via the inventive method. A second method uses a microscope to detect the presence or absence of solids, e.g., crystals, in an uncured finished coating composition. In this method, the finished composition and a control are stored at −20° C. for up to 7 days. They are removed from storage, and a count is taken of the number of particles of at least about 1 μm in size appearing in approximately 275,000 μm² (about 0.005-0.010 film thickness) of the finished composition and control under 100× magnification. If more than 10 particles are located in that sample of the finished composition, and no particles are detected in the control, the suspected component is a candidate for introduction into a coating composition via the inventive method. A third method involves passing the compositions (i.e., a finished composition and a control taken from storage, as described above) through filter paper, and inspecting the filter to detect the presence of any particulates thereon. Yet another method involves microscopic examination of a cured coating. Such an examination may also uncover the presence of undesirable particulates therein. For example, crystals are sometimes detected in a coated optical fiber that possess unacceptable performance characteristics, e.g., in an inner primary coating on a fiber that exhibits an unacceptable attenuation level. In these cases, an evaluation can readily be made to isolate the offending crystal-forming component. The inventive method can then be utilized to circumvent the undesirable, but inevitable, crystal formation.

The identity of haze-forming components may be determined by a variety of methods, although using a methodology similar to that used in connection with crystal-forming components provides acceptable results. As before, a final coating composition (with the suspected haze-forming incompatible component mixed therein) and a control composition (without the suspected component) are stored at −20° C. for at least one week. If a visible haze or cloudiness develops in the former, but not in the latter, the suspected haze-forming component is a candidate for introduction via the inventive method.

Hydrolyzate-forming components may be identified be by a number of methods. One suitable method involves an examination of the degree of hydrolyzation of the suspected hydrolyzate-forming component over a predetermined period of time, typically 6 months. If the initial amount of a suspected hydrolyzate-forming component is reduced by more than about 20 wt. % over that predetermined period, e.g., six months, the component introduced into a composition using the inventive method. By way of example, when alkoxysilanes are suspected, the absorption intensity of the Si—O bond is evaluated over a six month period using FTIR. Gas chromatography may also be used to evaluate the degree of hydrolyzation of the suspect component.

Turning now to the FIGURE, there is illustrated a schematic diagram of a preferred system capable of providing a continuous supply of a radiation-curable coating composition having a colorant and/or incompatible component incorporated therein in accordance with the present invention.

The preferred method begins by introducing a stock radiation-curable coating composition comprising at least one radiation-curable component into the liquid conduit via inlet line 1. The colorant, either alone or in a compatible solvent, reactive diluent or other suitable carrier, is introduced into the liquid conduit via line 2. As the process is designed to provide a continuous supply of colored coating composition, sufficient quantities of the stock composition and colorant should be available to complete a particular optical fiber run.

After introduction, the rate of flow of the stock coating composition through the liquid conduit and into a mixing zone is metered by a control system. The control system comprises a flow meter 4, a flow indicator controller 6 and a valve 5 controllable by the flow indicator controller 6. A second control system is provided to meter the colorant into the mixing zone. The colorant control system includes a colorant flow meter 8, a colorant flow indicator controller 9 and a valve 10 controllable by the colorant flow indicator controller 9.

The system advantageously includes a plurality of colorant control systems (not shown), one for each different colorant desired to be introduced into the stock coating composition. The preferred configuration and operation of each are the same as that described for the illustrated system.

A colorant ratio controller 12 is also provided. The ratio controller accepts commands from an operator designed to indicate the color desired in the final coating. Based upon the flow rate of the stock coating composition provided by the flow meter 4, the ratio controller 12 sends a signal to the appropriate colorant flow indicator controllers to affect the addition of specific colors, at certain flow rates. When a particular colorant flow indicator controller 9 receives a signal to add a given colorant, it opens its corresponding valve 10 to permit the selected colorant to flow toward the mixing zone at a rate appropriate to the rate of flow of the stock coating composition. By adjusting the colorant ratio controller, an operator can easily provide for the selective addition of one or more colorants to a stock coating composition on demand.

The colorants can be added to the stock composition at any point upstream of the mixing zone outlet. For example, the stock composition and colorants can be combined and then travel through the liquid conduit, undergoing further processing, before entering the mixing zone.

A totalizer 15 is provided to quantify the total amount of stock coating composition and colorant entering the mixing zone. This information can be used to monitor the amount of coating composition being produced over a given time period, and for other internal purposes.

The mixing zone can be any environment present in the colorant-additive system described herein capable of mixing the stock coating composition and colorants. Examples of conventional devices that are capable of providing such an environment are well known, and include static mixers (preferred), stirred tanks and the like.

A suitable mixing zone can also be provided within a coating applicator device. The latter, exemplified by draw towers that coating use dies to apply coatings, can generate sufficient turbulence to provide adequate mixing of stock compositions and colorants such that the objectives of the present invention are met. In a draw tower embodiment, the coating die is able to provide such turbulence, with the colorants being added at any juncture in the liquid conduit upstream of the die. Advantageously, the colorants are added just upstream of the die, but may also be introduced directly into the die.

In the illustrated embodiment, a vacuum pump 17 is advantageously provided to remove any volatile gases that may otherwise accumulate in the mixing tank 16. A level transmitter 18 in communication with a level indicator 19 is also provided as a safety feature. Should the level of liquid in the tank 16 exceed a preset level, the level transmitter 18, detecting the excessive level, will forward a signal to the level indicator 19. The level indicator 19, in turn, will forward a signal to the stock composition flow indicator controller 6 to close its corresponding valve 5, thereby terminating the flow of the composition into the tank 16. Conversely, if the level transmitter 18 detects a liquid level that is below a predetermined minimum, the transmitter will signal the low level controller 20 that will close tank outlet valve 21 until the predetermined minimum liquid level is reached.

In this embodiment, the mixing tank 16 is provided with an inlet 22 for admitting stock coating composition and an inlet 23 for admitting colorant. If desired, additional inlets (not shown) may be provided on the tank 16 as part of the overall system that permits the selective addition of colorants to a stock coating composition. It should be appreciated, however, that the inlet(s) may be located at any position(s) upstream of the mixing zone without departing from the present invention. Alternatively, all or part of the total number of colorants may be combined prior to their introduction into the tank 16, and admitted into the tank 16 via a single inlet.

Preferably, the inventive system contemplates that at least one of the colorant inlets 23 in the mixing tank 16 is provided with a first coupling device (not shown). Each of the containers holding a colorant is preferably provided with a second coupling device (not shown). While any known liquid-tight coupling system comprising the first and second coupling devices may be used, the coupling systems advantageously comprises a two-part quick-connect-disconnect coupling. Such couplings are well known to those skilled in the art, although they are used in other fields. In the preferred arrangement, mating of the first and second quick-connect-disconnect coupling devices permits a colorant to flow from the container into the mixing tank 16. This preferred arrangement allows an operator to easily change colorants between coating runs.

After the colorants are added and thoroughly mixed in the tank 16, a finished coating composition is provided. The finished coating composition exits the mixing tank 16, and is pumped though the liquid conduit to the device that applies the coating composition onto the optical fibers, commonly referred to as a draw tower (not shown).

Between the tank and the draw tower, several components are optionally provided. After the finished composition passes through the pump 24, a tranquilizer 26 may be provided to smooth out the pulsed flow of the finished composition as it emerges from the pump 24. Optional sampling equipment 27 may, if desired, be provided to evaluate the quality of the finished coating composition prior to its deposition onto the fiber. One more valves 29, 30 can be provided to permit intermittent sampling. Unused samples of the finished coating, or all of the coating composition emerging from the mixing zone (e.g., due to unacceptable quality) can be scrapped via three-way valve 31 and line 32.

A further option involves filtering the finished coating composition prior to deposition onto a fiber. This may be accomplished by means of valves 34, 35, 36 which are able to divert and direct the finished coating composition through a filter apparatus 38, such as a filter cartridge and housing. Pressure indicators 40, 41 may be provided on the upstream and downstream sides of the filter apparatus to calculate the pressure drop across the filter apparatus. When the pressure drop exceeds a predetermined maximum, indicating fouling of the filter media, new filter media, e.g., a filter cartridge, should be installed.

Prior to entering the draw tower via line 60, the flow rate of the finished coating composition is determined via a flow meter 43. The finished coating flow meter signals the finished coating flow indicator controller 44. This flow controller adjusts the position of the finished coating valve 45, but depends further upon the signal received from a system flow controller 50. The system flow controller 50 is provided with the same flow rate settings as the colorant 8 and stock coating 4 controllers. If the combined flow rate of the colorant and stock coating composition is less than the flow rate of the finished composition, the finished coating flow indicator controller 44 will close valve 45 to the extent necessary to achieve a balance between the material input and output. Conversely, if the combined flow rate is greater, valve 45 will be opened to prevent the undesirable accumulation of coating composition in the system.

Optionally, all or part of the finished coating composition may be retained in a holding tank 51 until needed at the device that is used to apply the coating onto the fiber, e.g., a draw tower. Of course, lengthy retention of the composition can lead to undesirable settling of certain colorants (e.g., pigments) and insoluble components. To optimize coating performance, the composition should be continuously provided to the coating device before excessive settling occurs, e.g., while the additives remain substantially uniformly dispersed therein. Advantageously, the coating composition is transported directly from the mixing zone into the applicator device.

A further embodiment contemplates providing more than one of the foregoing systems in a fiber optic coating facility. For example, in this embodiment, each system is used to provide continuous supplies of a different coating composition, e.g., one system provides an inner primary coating, a second provides an outer primary coating, and so on.

Any reference cited herein, including patents, patent applications, and publications, are hereby incorporated in their entireties by reference. Further, any reference herein to a component in the singular is intended to indicate and include at least one of that particular component, i.e., one or more.

While this invention has been described with an emphasis upon preferred embodiments, it will be obvious to those of ordinary skill in the art that variations of the preferred embodiments may be used and that it is intended that the invention may be practiced otherwise than as specifically described herein. Accordingly, this invention includes all modifications encompassed within the spirit and scope of the invention as defined by the following claims.

What is claimed is:

1. A method for continuously providing a radiation-curable coating composition for application onto optical fiber comprising
(a) continuously introducing a radiation-curable stock coating composition comprising at least one radiation-curable component into a mixing zone having a primary inlet and an outlet;
(b) selectively incorporating at least one additive selected from the group consisting of a colorant and an incompatible component into the stock coating composition upstream of the mixing zone outlet;
(c) mixing the at least one additive and stock coating composition in the mixing zone to provide a radiation-curable finished coating composition;
(d) continuously applying the finished coating composition onto optical fiber.

2. The method according to claim 1, the mixing zone further comprising a secondary inlet through which the at least additive is added to the stock coating composition in the mixing zone.

3. The method according to claim 2, wherein the secondary inlet further comprises a first coupling device.

4. The method according to claim 3, wherein the at least one additive is supplied from a container having a second coupling device, the mating of the first and second coupling devices permitting the at least one additive to be added to the stock coating composition.

5. The method according to claim 4, the mixing zone comprising a plurality of secondary inlets having first coupling devices, wherein a plurality of additives are supplied from a plurality of containers each comprising a second coupling device, the mating of each first and second coupling devices permitting each respective additive to be selectively added to the stock coating composition.

6. The method according to claim 1, wherein each of the at least one additive is added to the stock coating composition at a preselected flow ratio.

7. The method according to claim 6, further including, for each of the at least one additive added upstream of the mixing zone, a flow ratio controller, a stock material flow control system for controlling the flow rate of stock coating composition into the mixing zone and reporting the flow rate to the flow ratio controller, an additive flow control system for controlling the flow rate of each of the at least additive into the mixing zone and receiving flow rate commands from the flow ratio controller, wherein the flow ratio controller sends flow rate commands to the additive flow control system upon receiving reports from the stock material flow control system based upon a pre-determined flow ratio.

8. The method according to claim 7, wherein each additive flow control system comprises a flow indicator controller and a valve controlled by the flow indicator controller.

9. The method according to claim 8, wherein each stock material flow control system comprises a flow indicator controller and a valve controlled by the flow indicator controller.

10. The method according to claim 7, wherein the mixing zone comprises a static mixer.

11. The method according to claim 1, wherein the mixing zone is a coating die.

12. The method according to claim 1, further comprising filtering the finished coating composition before continuously applying the coating onto the optical fiber.

13. The method according to claim 1, wherein the finished coating composition resides in a holding tank prior to application onto the optical fiber and while the at least one additive remains substantially uniformly dispersed in the finished coating composition.

14. The method according to claim 1, further comprising optionally sampling the finished coating composition before continuously applying the coating onto the optical fiber.

15. The method according to claim 1, wherein the finished coating composition is an inner primary coating.

16. The method according to claim 1, wherein the finished coating composition is an outer primary coating.

17. The method according to claim 1, wherein the finished coating composition is a matrix coating.

18. The method according to claim 1, wherein the finished coating composition is an ink.

19. The method according to claim 1, wherein the radiation-curable component is ethylenically unsaturated and includes at least one functional group selected from the group consisting of acrylates, methacrylates, styrenes, vinylethers, vinyl esters, N-substituted acrylamides, N-vinyl amides, maleate esters and fumarate esters.

20. The method according to claim 1, wherein the at least one additive is a colorant.

21. The method according to claim 20, wherein the colorant is selected from the group consisting of reactive dyes, non-reactive dyes, dye precursors and mixtures thereof.

22. The method according to claim 1, wherein the at least one additive is an incompatible component.

23. The method according to claim 22, wherein the incompatible component is selected from the group consisting of crystal-forming components, haze-forming components, hydrolyzate-forming components, and mixtures thereof.

24. The method according to claim 23, wherein the crystal-forming components are selected from the group consisting of antioxidants, photoinitiators, radiation-curable low molecular weight ethylenically unsaturated components and mixtures thereof.

25. A system for continuously providing a radiation-curable coating composition for application onto optical fiber comprising
(a) a liquid conduit for transporting a radiation-curable coating composition to a fiber optic coating applicator;
(b) an inlet in the liquid conduit that permits the selective introduction of a stock radiation-curable coating composition therein;
(c) an inlet in the liquid conduit that permits the selective introduction of at least one additive selected from the group consisting of a colorant and an incompatible component therein;
(d) a zone in the liquid conduit that provides for continuous mixing of the at least one additive and the radiation-curable stock coating composition, wherein a radiation-curable finished coating composition is provided;
(e) a fiber optic coating applicator that continuously applies the radiation-curable finished coating composition onto optical fiber.

26. The system according to claim 25, the liquid conduit further comprising a plurality of inlets, wherein each of a plurality of additives is selectively introduced into the liquid conduit through a corresponding inlet.

27. The system according to claim 26, wherein each inlet comprises a first coupling device.

28. The system according to claim 27, wherein each additive is supplied from a container having a second coupling device, the mating of the first and second coupling devices permitting the at least one additive to be introduced into the liquid conduit.

29. The system according to claim 26, further including, for each additive, a flow ratio controller, a stock material flow control system for controlling the flow rate of stock coating composition into the mixing zone and reporting the flow rate to the flow ratio controller, an additive flow control system for controlling the flow rate of each of the at least additive into the mixing zone and receiving flow rate commands from the flow ratio controller, wherein the flow ratio controller sends flow rate commands to the additive flow control system upon receiving reports from the stock material flow control system based upon a pre-determined flow ratio.

30. The system according to claim 29, wherein each additive flow control system comprises a flow indicator controller and a valve controlled by the flow indicator controller.

31. The system according to claim 30, wherein each stock material flow control system comprises a flow indicator controller and a valve controlled by the flow indicator controller.

32. The system according to claim 25, wherein the mixing zone comprises a static mixer.

33. The system according to claim 25, wherein the mixing zone is a coating die located in the fiber optic coating applicator.

34. The systems according to claim 25, further comprising (f) a device that emits radiation of a type and in an amount sufficient to cure the finished coating composition.

35. The system according to claim 25, further comprising first and second sets of components (a)-(e), wherein the first set is for applying a radiation-curable inner primary coating composition onto optical fibers and the second set is for applying a radiation-curable outer primary coating composition, a radiation-curable ink composition or a radiation-curable matrix material composition onto optical fibers.

36. The system according to claim 35, wherein the second set of components is for applying an outer primary coating onto optical fibers.

37. The system according to claim 36, further comprising a third set of components (a)-(e), wherein the third set is for applying a radiation-curable ink composition onto optical fibers.

38. The system according to claim 37, further comprising a fourth set of components (a)-(e), wherein the fourth set is for applying a radiation-curable matrix material composition onto optical fibers.
